(19) United States
(12) Patent Application Publication
(10) Pub. No.: US 2026/0243732 A1
(43) Pub. Date: Aug. 20, 2026

(54) GUIDED WAVE ULTRASOUND TESTING (GWUT) METHOD FOR HiCAM NDE

(71) Applicant: University of South Carolina, Columbia, SC (US)

(72) Inventors: Sourav Banerjee, Irmo, SC (US); William Ward, Manning, SC (US); Hossain Ahmed, Statesboro, GA (US)

(73) Assignee: University of South Carolina, Columbia, SC (US)

(21) Appl. No.: 19/423,740

(22) Filed: Dec. 17, 2025

Related U.S. Application Data
(60) Provisional application No. 63/759,795, filed on Feb. 18, 2025.

(51) Int. Cl. G01N 29/22; G01N 29/04; G01N 29/44

(52) U.S. Cl. CPC G01N 29/221; G01N 29/04; G01N 29/225; G01N 29/4445; G01N 2291/267

(57) ABSTRACT

Described herein are automated and versatile systems and methods utilizing a Guided Wave (“GW”) ultrasound concept that inspects materials (isotropic or anisotropic) system fast and reliably. Currently, every material system needs redesign of the GW setup. The proposed setup would be a universal, one stop solution for all material systems. This would increase the speed of inspection during manufacturing and also for post manufacturing inspection.

### STATEMENT REGARDING FEDERALLY SPONSORED RESEARCH

This disclosure was made with government support under NASA Langley Research Center award 80NSSC22M0155. The government may have certain rights in the disclosure.

### TECHNICAL FIELD

The subject matter disclosed herein is generally directed to an automated and versatile system utilizing a Guided Wave (“GW”) ultrasound concept that inspects materials (isotropic or anisotropic) system fast and reliably. Currently every material system needs redesign of the GW setup. The proposed setup would be a universal, one stop solution for all material systems. This would increase the speed of inspection during manufacturing and also for post manufacturing inspection.

### BACKGROUND

Ultrasonic Nondestructive evaluation (NDE) is a method of inspecting structural materials like plates and rods or joints without breaking them or dismantling them. Guided wave (GW) provided opportunity to inspect the materials and structures where access to the structure is restricted or it is difficult to perform traditional pulse-echo or phased-array ultrasound NDE. Guided Wave (GW) is a form of ultrasonic stress wave that can propagate in a material for long distance. GW saturates the whole thickness of the material. GW creates the opportunity to inspect joints, corner and large structures much faster.

GW propagates in a material with different modes, primarily Symmetric, Antisymmetric and Shear Horizontal wave modes. Velocity of these wave modes are equal in all possible directions of wave propagation in isotropic materials (e.g., metal like aluminum, steel etc.). However, in anisotropic materials (e.g., composites) wave velocities of these modes are different in different directions. Wave velocities depend on the material properties, for example, elastic modulus, shear modulus, Poisson's ratio, density of each layer and material layups.

The typical method of generating a GW is governed by Snell's law. Thus, to generate a GW mode of specific velocity, a specific angle of wave incidence is required. In an isotropic material, as the velocity is equal in all directions, the angle of wave incidence required is also constant for a specific wave mode. Different wave modes may require different angles of wave incidence, but as long as the material is isotropic the angle remains constant for all possible direction of propagation of that specific wave mode. This scenario breaks down in anisotropic material. The required angle of incidence not only changes for different modes; it changes for different direction of propagation. To inspect composite materials during manufacturing or after manufacturing, currently, every material system needs redesign of the GW setup as the angle of wave incidence and reception depends on material system being inspected.

Accordingly, it is an object of the present disclosure to provide a versatile product system that can be applied to all material systems in fast production environment with appropriate apparatus, hardware and software.

Citation or identification of any document in this application is not an admission that such a document is available as prior art to the present disclosure.

### SUMMARY

The above objectives are accomplished according to the present disclosure by providing a system that checks materials without damaging them by sending guided waves into the material and receiving the waves that come back. Both the transmitter and receiver can rotate freely in any direction to scan from different angles on a hemisphere. Further, the waves can be set to one of three types: symmetric, antisymmetric, or shear horizontal. Still yet, the transmitter may be mounted on one robotic arm, and the receiver is mounted on another robotic arm. Moreover, a pulser may send ultrasound pulses into the transmitter. Yet again, an oscilloscope may record the signals from the receiver. Furthermore, the transmitter and receiver may be placed at two different spots along a weld. Still further, the recorded signals may be used to create a “waterfall diagram” (a visual representation of the data). Further again, if there is a defect in the material, it may show up as an irregularity in the waterfall diagram. Again still, a best angle for scanning may be found by moving the transmitter and receiver along mirrored arcs until the signal-to-noise ratio is highest, then positioning them at that angle. Further yet, the transmitter and receiver may not touch the material being analyzed directly.

In a further embodiment, the disclosure provides a method for checking materials without damaging them by sending guided waves into the material, receiving the waves that come back, and rotating the transmitter and receiver to scan from different angles on a hemisphere. Further, the guided waves may be selected from a symmetric, antisymmetric, or shear-horizontal mode. Yet still, the transmitter may be fitted one robotic arm and the receiver fitted another robotic arm. Moreover, a pulser may send ultrasound pulses into the transmitter. Still again, the signals from the receiver may be captured using an oscilloscope. Again, the transmitter and receiver may be positioned at two different spots along a weld. Still further yet, a waterfall diagram may be generated from the captured signals. Yet again, defects may be detected by looking for irregularities in the waterfall diagram. Further again, a best angle for transmitting and receiving may be found by moving the transmitter and receiver along mirrored arcs until the signal-to-noise ratio is highest, then positioning them at that angle. Further again, the scanning may be performed without the transmitter or receiver touching the material.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows an guided wave propagation with the relation between the propagation angle and the incidence angle of wave following the Snell's law.

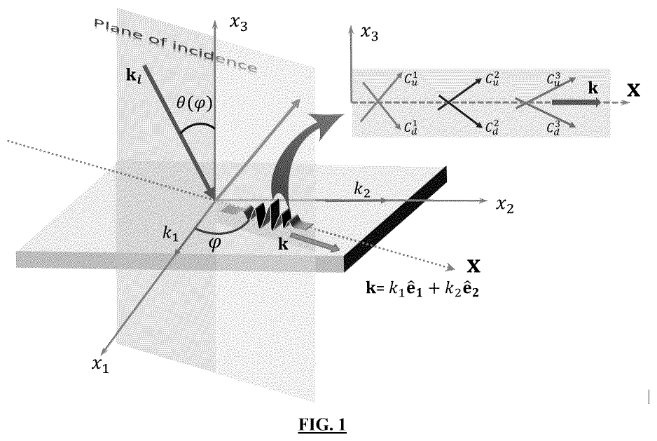

FIG. 2 shows stacking profile of plates used in this disclosure and orientation of the plates.

FIG. 3 shows photographs of stacked profile of plates that were tested.

FIG. 4 shows one embodiment of a testing set up of the disclosure.

FIG. 5 shows photographs of one embodiment of the testing set up.

FIG. 6 shows the testing setup employing an acrylic water bath and aluminum alloy rail track.

FIG. 7 shows further illustrations and photos of one embodiment of a testing setup of the current disclosure.

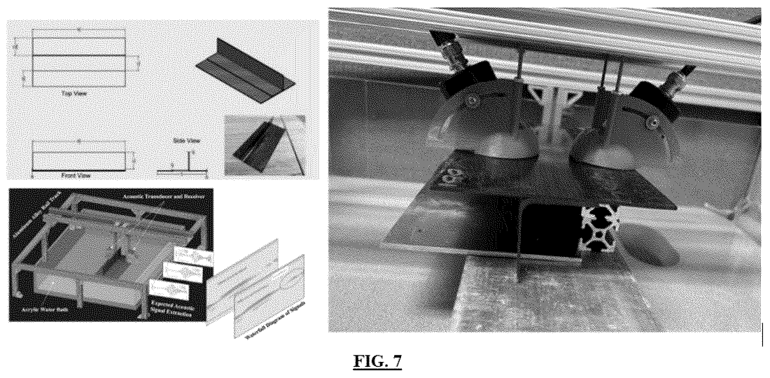

FIG. 8 shows a full waterfall diagram and latent waves packets for a L stringer welded to a plate.

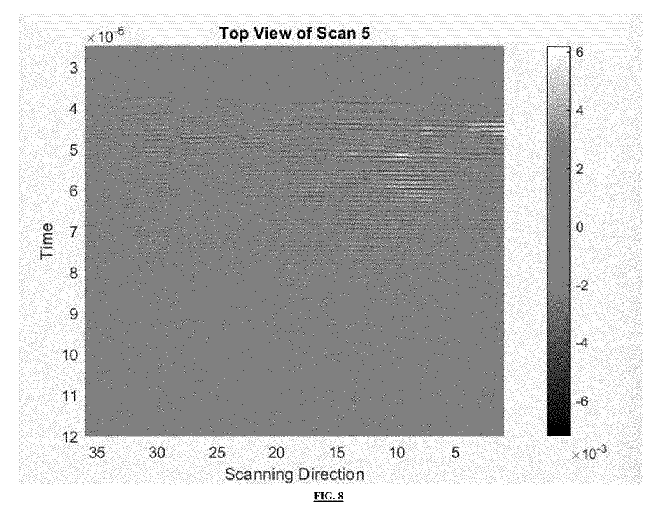

FIG. 9 shows a full waterfall diagram and the latent wave packets for the 8 ply Omega Stringer [0 45 90 −45 0]s welded to a 8 ply Plate [0 45 90 −45 0]s.

FIG. 10 shows a full waterfall diagram and the latent wave packets for the omega stringer [0/90/0/90]s welded to a plate [0/90/0/90]s.

FIG. 11 shows a full waterfall diagram and the latent wave packets for the [0/45/90/−45/0]s plate welded to a [0/45/90/−45/0]s plate.

FIG. 12 shows a full waterfall diagram and the latent wave packets for the two [0/90/0/90]s plates welded together in a Lap joint.

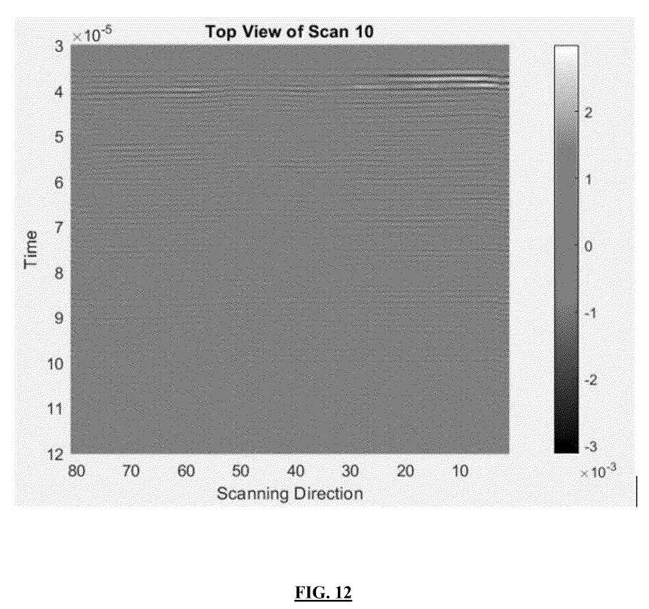

FIG. 13 shows graphs of velocity and frequency for guided waves.

FIG. 14 shows photographs of composite plates.

FIG. 15 shows an illustration of laminate orientation codes.

FIG. 16 shows a photograph of a composite plate with pristine Marcelled configuration.

FIG. 17 shows experimental setup components for one embodiment of the testing apparatus.

FIG. 18 shows photos of an acoustic transduce and acoustic receiver on a composite plate.

FIG. 19 shows photos of an acrylic hemispherical component and an acrylic inverted hollow hemispherical component.

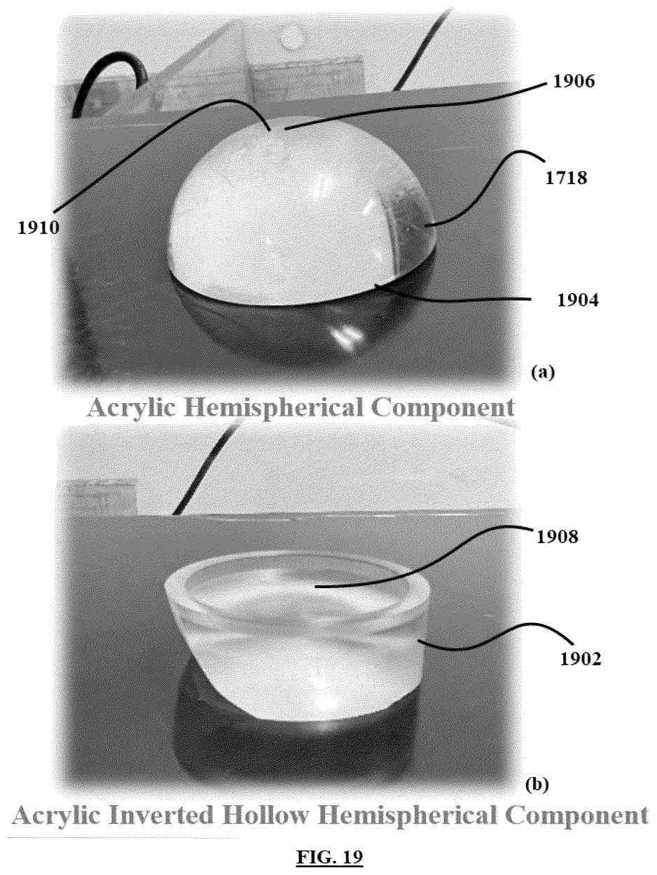

FIG. 20 shows an illustration of a 3-D printed casing of the current disclosure.

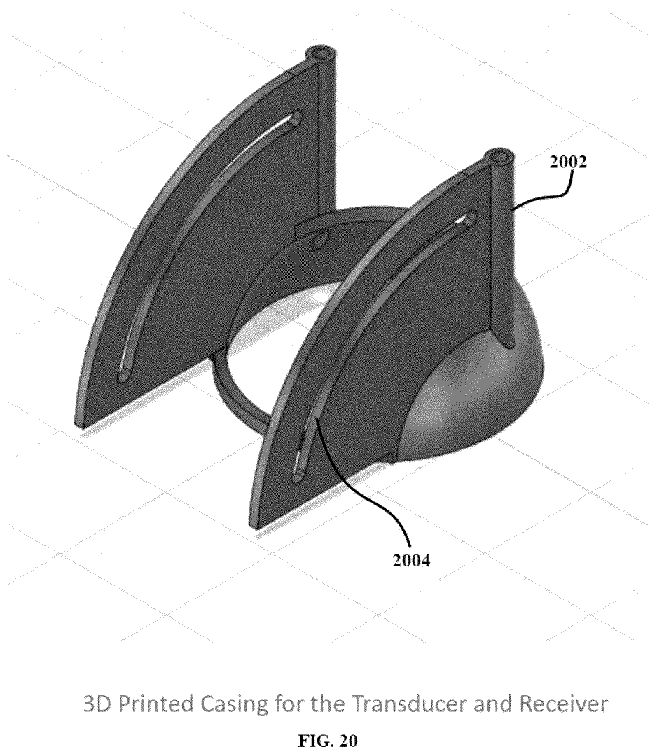

FIG. 21 shows a control panel for use with the current disclosure.

FIG. 22 shows a graph of acoustic receiver output from a 0/90 Pristine Composite Plate.

FIG. 23 shows an illustration of a testing setup rail system of the current disclosure.

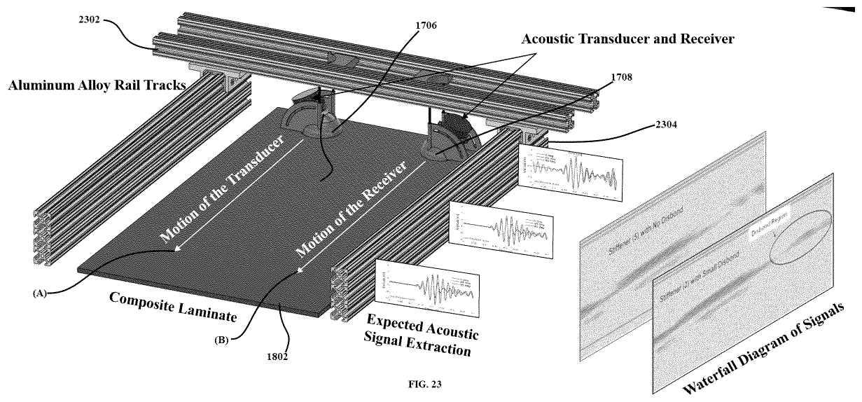

FIG. 24 shows a further embodiment where water jets 2402 may contact the testing surface.

FIG. 25 shows both contact and non-contact embodiments for the current disclosure.

FIG. 26 shows an alternative configuration of the testing system where the acrylic members are replaced with water containers.

FIG. 27 shows using blocks with formed angles to hold the transducer and receiver in place with respect to the testing surface.

FIG. 28 shows a further embodiment wherein the acoustic transducer and acoustic receiver are affixed to robotic arms.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a” “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, “substantially pure” can mean an object species is the predominant species present (i.e., on a molar basis it is more abundant than any other individual species in the composition), and preferably a substantially purified fraction is a composition wherein the object species comprises about 50 percent of all species present. Generally, a substantially pure composition will comprise more than about 80 percent of all species present in the composition, more preferably more than about 85%, 90%, 95%, and 99%. Most preferably, the object species is purified to essential homogeneity (contaminant species cannot be detected in the composition by conventional detection methods) wherein the composition consists essentially of a single species.

As used interchangeably herein, the terms “sufficient” and “effective,” can refer to an amount (e.g., mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g., a web interface.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the testing systems and/or testing methods described herein can be presented as a combination kit. As used herein, the terms “combination kit” or “kit of parts” refers to the equipment, instruments, materials, and any additional components that are used to conduct and/or provide the combination of elements or a single element, such as the testing systems and/or testing methods contained therein. Such additional components include, but are not limited to, packaging, blister packages, and the like. When one or more of the equipment, instruments, materials, and any additional components described herein or a combination thereof (e.g., items contained in the kit are provided simultaneously, the combination kit can contain the equipment, instruments, materials, and any additional components in a single formulation, such as a complete testing set-up or in separate embodiments or portions. When the equipment, instruments, materials, and any additional components described herein or a combination thereof and/or kit components are not provided simultaneously, the combination kit can contain each agent or other component in separate embodiments. The separate kit components can be contained in a single package or in separate packages within the kit.

In some embodiments, the combination kit also includes instructions printed on or otherwise contained in a tangible medium of expression. The instructions can provide information regarding the equipment, instruments, materials, and any additional components, safety information regarding the content of the c equipment, instruments, materials, and any additional components, information regarding use, testing procedures, testing guidelines for the equipment, instruments, materials, and any additional components contained therein. In some embodiments, the instructions can provide directions and protocols for using the equipment, instruments, materials, and any additional components described herein to a test material. In some embodiments, the instructions can provide one or more embodiments of the methods for using the system such as any of the methods described in greater detail elsewhere herein.

Ultrasonic Nondestructive evaluation (NDE) is a method of inspecting structural materials like plates and rods or joints without breaking them or dismantling them. Guided wave (GW) provides the opportunity to inspect the materials and structures where access to the structure is restricted or it is difficult to perform traditional pulse-echo or phased-array ultrasound NDE.

Guided Wave (GW) is a form of ultrasonic stress wave that can propagate in a material for long distance. GW saturates the whole thickness of the material. GW creates the opportunity to inspect joints, corner and large structures much faster.

GW propagates in a material with different modes, primarily Symmetric, Antisymmetric and Shear Horizontal wave modes. Velocity of these wave modes are equal in all possible direction of wave propagation in isotropic materials (e.g. metal like aluminum, steel etc.). However, in anisotropic materials (e.g. composites) wave velocities of these modes are different in different directions. Wave velocities depend on the material properties, for example, elastic modulus, shear modulus, Poisson's ratio, density of each layer and material layups.

The typical method of generating a GW is governed by Snell's law (see slides). Thus, to generate a GW mode of specific velocity, a specific angle of wave incidence is required. In an isotropic material, as the velocity is equal in all directions, the angle of wave incidence required is also constant for a specific wave mode. Different wave modes may require different angles of wave incidence, but as long as the material is isotropic the angle remains constant for all possible direction of propagation of that specific wave mode. This scenario breaks down in anisotropic material. The required angle of incidence not only changes for different modes it changes for different directions of propagation.

Currently there is no system that can be versatile to change the angle of wave incidence as needed during the inspection of the composite materials. A system is required to access any wave mode along any specific direction of inspection, with increased signal to noise (SNR) ratio.

To trigger any GW mode along any direction as needed a system is designed in this disclosure. The concept of the versatile system is made of fixtures and apparatus that are versatile to rotate the Transducer (an ultrasonic probe that inject the wave energy into the material) on any plane about any axis to access all possible angles on a surface of a hemisphere. Similarly, simultaneously, the concept of the versatile system is made of fixtures and apparatus that is versatile to rotate the Receiver (an ultrasonic probe that receives the ultrasonic wave energy coming out or leaking out of the material) on any plane about any axis to access all possible angles on a surface of a hemisphere.

Currently to demonstrate feasibility rotation about y-z plane about x axis and on x-z plane about y axis is fabricated. However, a completely versatile system could also be fabricated. The concept is to mount the apparatus on a robotic arm and make it automated. Automation with versatility of GW inspection system is the key for this innovation. Currently every material system needs redesign of the setup as the angle of wave incidence and reception depends on material system. The proposed setup would be universal, one stop solution for all material system. This would increase the speed of inspection during manufacturing and also for post manufacturing inspection.

In one embodiment of the GWUT setup, a track was used to hold ultrasound transducer and receiver combination linearly across from one another. The transducer and receiver were placed at an angle mirror image to each other to ensure the maximum Signal to Noise Ratio (SNR). Specific angle of incidence was tuned for each specimen for maximum possible SNR. A pulser is used to induce ultrasound pulse to the transducer which is directed into the material. After materials interact with the incident ultrasonic wave at a specific incident angle, the Guided Wave is generated. The generated Guided Wave then propagates along the test article. While propagating by virtue of the physics of wave propagation, the wave leaks into the surrounding media. This means that the receiver placed on the test article will receive a signal. The signal was captured using an oscilloscope and correspondingly a wave form. This scenario repeated along the scanning direction. The data collected along the scanning direction were placed into a waterfall diagram. The results of these waterfall diagrams show the opportunity of utilizing GWUT systems as a potential NDE tool for the post process NDE of thermoplastic composite welds. It can be seen that the plate with Marcelling and Welds behaves differently. Welded specimens tested were free from obvious defects. Thus, continuous waterfall diagrams were achieved.

In these experiments, Guided Waves were also used to see if Marcelling affects the ultrasound signals. Guided Waves are currently used in NDE to determine the structural integrity of various isotropic and anisotropic materials. Waves in isotropic material are easier to understand. However, waves in anisotropic material like thermoplastic composite plates and welds are difficult to understand. Waves in anisotropic material take a specific wave velocity along the incident plane to match the wave number vectors in the incident material and material of interest, which is here the thermoplastic composite plates.

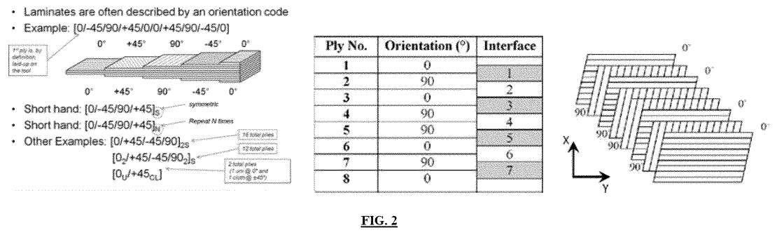

In these experiments, ultrasound waves were sent at a specific angle to the specimen, via the transducer, which then propagated through the material. The propagating wave and its leaked energy was collected by a receiver on the opposite side of the weld or at a specific distance. In most cases, these waves will not travel through the air pockets in the material but instead cause scattering and attenuation. The specific plates which were tested had a stacking profile [0/45/90/−45/0]s and [0/90/090]s as depicted in FIG. 2. Of these plates two had Marcelled zones and two were pristine plates. The perks of using GWUT over its counter parts, phased array or focus point analysis, are that it facilitates large area inspection comparatively faster. GWUT methods could inspect the structural integrity of welded thermoplastic composite plate. Structural skins and stringers are often joined through a welding process. The linear integrity of the welded joints must be inspected as fast as possible. GWUT creates an opportunity to inspect the health of the welds through fast and effective linear scans. The main goal of this experiment is to demonstrate the feasibility of scanning the welded joints using GWUT system employing physics informed linear scans that can create highly informative ultrasonic waterfall diagrams. Waterfall diagrams will be visual images of the health of the welds. Any anomaly, defects, or defected joints will create disrupted and irregular waterfall diagram. Later under the realm of NDE 4.0, artificially intelligent (AI) algorithms could be used to diagnose the health of the welds by analyzing the waterfall diagrams artificially without human intervention. This will expedite the NDE of welded joints significantly, several fold faster than current SOA. At some point GWUT will allow for a process which will test the structural integrity of a welded joint in aircraft structures immediately after being welded or while it is getting welded (opening the door for in-situ NDE). This would allow for high-rate manufacturing and production of composite structures.

Data was collected in space-time matrix format. Time is the scale to record the ultrasonic signal at a specific linear position of the transducer-receiver location with respect to the reference point, e.g. along the width of the welds. Space is the scale to record the linear distance along the specimen, e.g. along the length of the welds. During this experiment all data were collected (in *.csv format) and organized into a large matrix to plot the waterfall diagrams for each specimen, respectively. This process was done using a custom developed MATLAB code. Inputs were the number of scanning points and the number of test runs. The code works by organizing all the *.csv files. A start point was found by reading the lowest file number. Starting from the lowest number the data were read to the highest file number counting all the *.csv files that were collected. Each file was then read from the start point to its end cell in the respective data files. This is followed by saving this data in a main channel data matrix. This data matrix is then plotted in a waterfall diagram.

### Instruments Used:

JSR DPR300 Pulser-Receiver
Tektronix MDO3024 Mixed Domain Oscilloscope
Transducer and receiver along with respective cables
Custom built linear motion track
Plexiglass (crystal PTZ) connector piece and hemispherical PTZ piece
Transducer case to hold PTZ pieces and transducer.

The setup for this experiment begins with turning on the computer for the pulser, followed by turning on the pulser and oscilloscope. Next the JSR program was open on the computer screen and connectivity with the pulser was ensured. The settings for the JSR and the oscilloscope are completely optional and can be chosen for each situation.

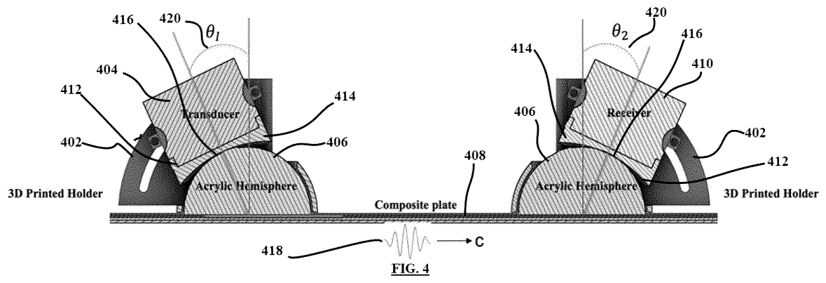

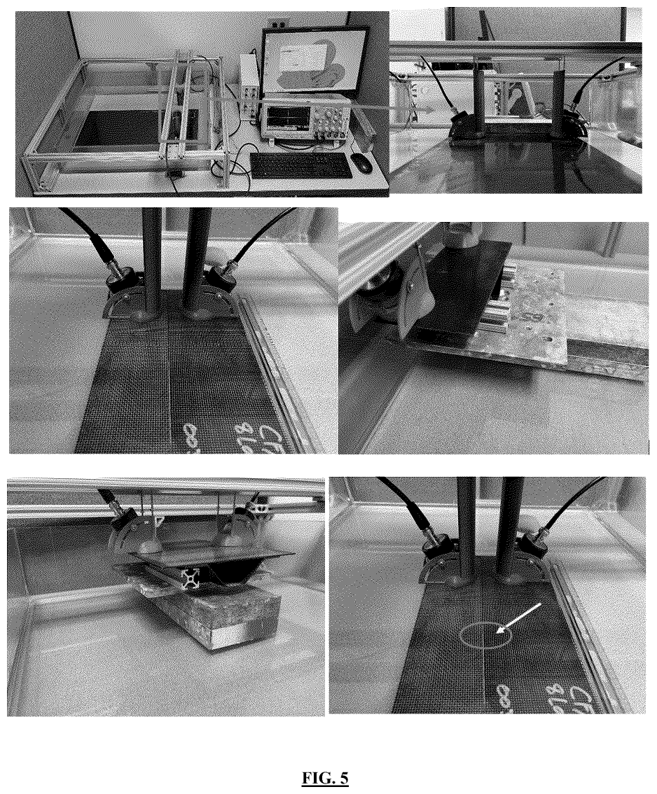

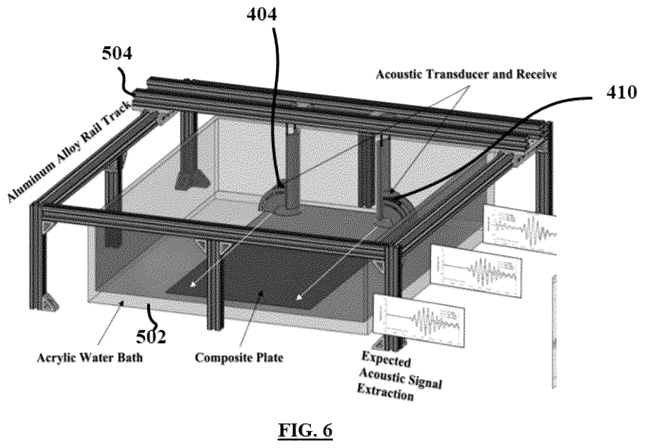

FIG. 4 shows a 3D printed holder 402, which holds transducer 404, and engages with acrylic hemisphere 406, which sets atop composite plate 408. Opposite this, another 3D printed holder 402 engages receiver 410 which is angled with respect to another acrylic hemisphere 406. This experiment begins by placing the hemispherical PTZ pieces, acrylic hemispheres 406, into the bottom of the 3D printed case. Next ultrasound gel 412 was placed on the bottom and top of the connector piece 414 and they were then placed on top of spherical side 416 of the half-sphere piece. This is then followed by placing transducer 404 on top of the indented side of connector piece 414. These steps were repeated with the receiver side. Transducer (T) 404 and Receiver (R) 410 were then connected with the BNC cables, one to the pulser (T) and one to the oscilloscope (R). Next the track was moved as far to the left as possible allowing room for a composite plate to be placed underneath. FIG. 5 shows photographs of the above set up. FIG. 6 shows the above setup employing an acrylic water bath 502 and aluminum alloy rail track 504.

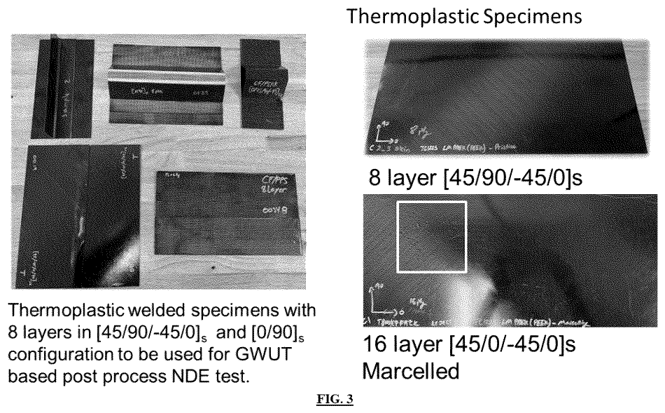

This is then followed by pouring water over the plate until it is submerged with around 2-3 mm of clearance. The next step was to set the distance between transducer 404 and receiver 410. This distance is governed by the SNR and also the clearance distance available beyond the welded zone. Once this distance is set, the incident angles can be found. This starts by putting the screws into the side of the case and into the collar of transducer 404 and receiver 410. Now by moving transducer 404 and receiver 410 along the outer arc mirroring each other a primary angle can be locked in. The angle is found when the SNR is highest. Once the structure and the transducer/received system are in the locked position, the track holding the transducer/received system was moved for scanning. Scanning was performed incrementally. In this test the scanning was done manually and thus the track was moved every 1 or 5 mm as applicable and data was collected. However, this setup could be automated employing robotics system and scanning could be done much faster at higher resolution with 10 μm. FIG. 3 shows a scanning setup for a lap welded joint.

Scan data is taken by saving the signal found from the oscilloscope. Pressing the save button on the oscilloscope will save the data *.csv file to a local drive. To start the scan first data was saved and then the track was moved at a given increment. By pressing the save button at every increment until the end of the plate is reached, all *.csv files containing the GWUT ultrasonic scan data were collected. Once this is done the data was retrieved from the local drive and transferred to a secured computer approved for the HiCAM project at USC. Using the MATLAB code discussed earlier the files were read and respective waterfall diagrams were created.

The data for this experiment will be presented for each of the different specimens. For each run a waterfall graph was created which will visually show all the data collected during the experiment. This is followed by a top view of the waterfall graph which cuts out the trigger and all the unnecessary data at the end of the scan (we call coda data). The color pallet used was hot and will be consistent for each scan. Any exceptions will be noted in the scan notes. As for the graphs, each tick in the time axis is 4 nano seconds for 40 us viewing window and 2 nanoseconds for 20 us viewing window.

Each test run for each specimen had certain specific settings. For the first four scans the settings were the same. The JSR pulser settings were:
Gain: 30 dB
Voltage: 100 V
Low Pass Filter: 3 MHz
High Pass Filter: 1 MHz
PRF: 1.25 kHz
Energy Control: High
Dampening: 333 Ohms
Pulser Impedance: High
Trigger Source: Internal
The settings from the 2D linear motion track were.
Distance between the transducer and receiver: 8.25 inches
Incident angle (transducer and receiver measured from the horizon): 54°
Distance between two spatial points: 5 mm
Coupling: Water and Gel
Note: Two metal blocks were placed on each side of the specimen for stability.

### GWUT of Welded Joints

Test: L Stringer Welded to a Plate [0/45/90/−45/0]s
JSR settings [Voltage: 100V, Gain: 30 dB, Low Pass Filter: 3 MHz, High Pass Filter: 1 MHz, PRF: 800 Hz, Dampening: 44 Ohms, Pulser Impedance: HIGH, Energy Control: LOW]
Oscilloscope settings [Mode: 512 averaging, viewing window: 20 us, Y axis zoom: 10 mV]
Track Settings: [Angle Transducer/Receiver 54 degrees, Distance Apart: 4½ inch, Increment: 5 mm]
Coupling: Ultrasonic Gel, Weld is free from water

The scan was performed using ultrasound gel 412 as a coupling agent between the hemispherical PTZ, acrylic hemispheres 406, and the plate. Please note that while scanning with ultrasound gel 412, the ultrasound gel 412 was neither supplied continuously nor reinstated by lifting the contact except towards the end between 30-35 mm. This caused some loss of signal as the scanning length increased. A mechanism replenishing ultrasound gel 412 should be worked out such that SNR is not diminished. This is something to be considered in the next phase of HiCAM. The diminishing signal can be seen clearly in the waterfall diagram above due to loss of ultrasound gel 412. Despite loss of ultrasound gel 412, the waterfall diagram was successfully created and no defects were identified due to total loss of signal. The weld was known to be free from any defects.

### Test: Omega Stringer [0 45 90 −45 0]s 8 Ply Welded to a Plate [0 45 90 −45 0]s 8 Ply

JSR settings [Voltage: 100V, Gain: 30 Db, Low Pass Filter: 3 MHz, High Pass Filter: 1 MHz, PRF: 800 Hz, Dampening: 44 Ohms, Pulser Impedance: LOW, Energy Control: LOW]
Oscilloscope settings [Mode: 512 averaging, viewing window: 20 us, Y axis zoom: 10 mV]
Track Settings: [Angle Transducer/Receiver 54 degrees, Distance Apart: 7¾ inches, Increment: 1 mm]
Coupling: Ultrasonic Gel, Weld is free from water
Note: This scan was performed with ultrasound gel. Except diminishing ultrasound signal due to loss of the gel no indication of defects was found.
   Test: 8 Ply Omega Stringer [0/90/0/90]s Welded to a 8 Ply Plate [0/90/0/90]s
JSR settings [Voltage: 153V, Gain: 30 Db, Low Pass Filter: 3 MHz, High Pass Filter: 1 MHz, PRF: 1.25 kHz, Dampening: 333 Ohms, Pulser Impedance: HIGH, Energy Control: LOW]
Oscilloscope settings [Mode: 512 averaging, viewing window: 20 us, Y axis zoom: 10 mV]
Track Settings: [Angle Transducer/Receiver 54 degrees, Distance Apart: 5⅝ inches, Increment: 2 mm]
Coupling: Ultrasonic Gel, Weld is free from water

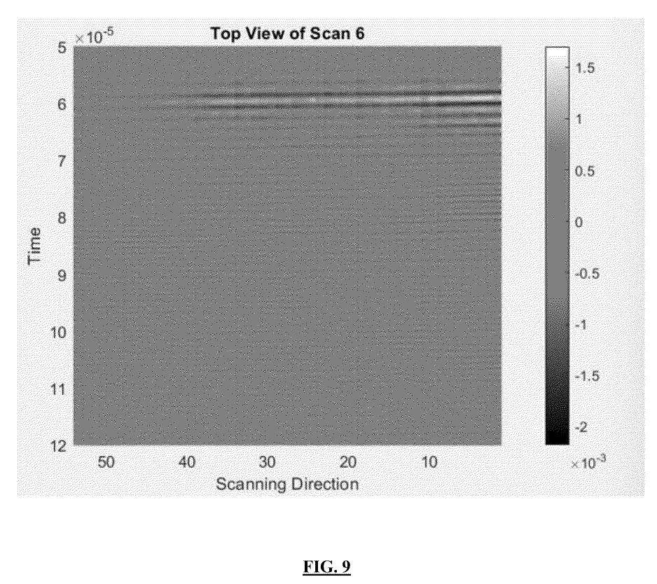

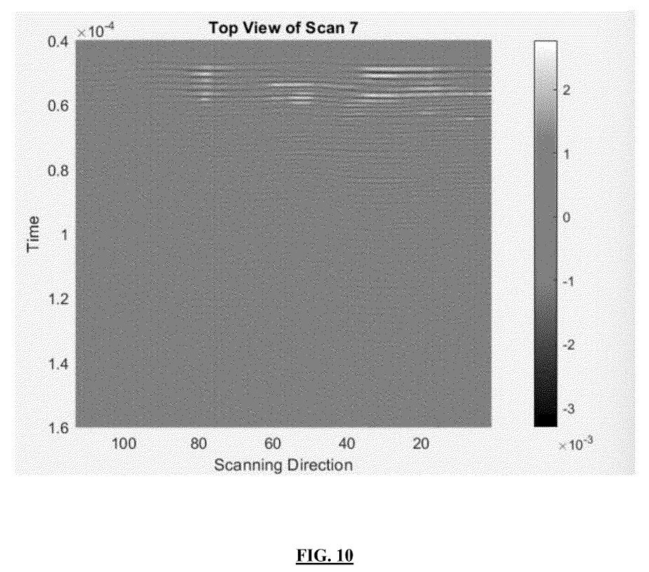

Note: This scan was performed with ultrasound gel 412. Except diminishing ultrasound signal due to loss of ultrasound gel 412, no indication of defects was found. Additionally, signal bifurcation and reunion of the guided wave modes due through 2 wave guides (one base plate and second omega stringer) are visible. Two sets of strong wave packets are visible at a consistent distance along the time scale both in FIG. 9 and FIG. 10.

Test: Welded Lap Joint Between Two 8 Ply [0/45/90/−45/0]s Plates
JSR settings [Voltage: 100V, Gain: 30 Db, Low Pass Filter: 3 MHz, High Pass Filter: 1 MHz, PRF: 1.25 kHz, Dampening: 333 Ohms, Pulser Impedance: HIGH, Energy Control: LOW]
Oscilloscope settings [Mode: 512 averaging, viewing window: 20 us, Y axis zoom: 5 mV]
Track Settings: [Angle Transducer/Receiver 54 degrees, Distance Apart: 2¾ inches, Increment: 3 mm]
Coupling: Ultrasonic Gel, Weld is free from water

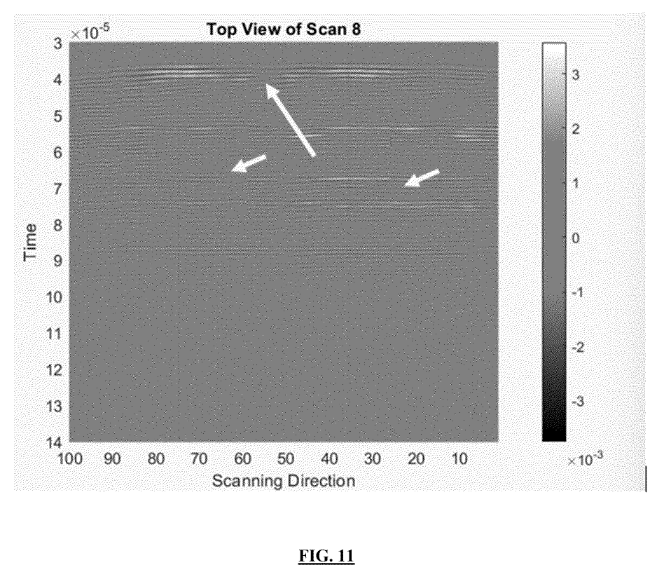

Note: This scan was performed with ultrasound gel 412. Except diminishing ultrasound signal due to loss of ultrasound gel 412, some indication of defects was found. The wave signal was lost consistently at the similar location identified in FIG. 11, see arrows. The specimen has no known defects. However, the GWUT system detected some form of defect, e.g. delamination of disbond in the weld. The specimen is required to be investigated further using other NDE tools. USC will utilize Scanning Acoustic Microscopy (SAM) to find out if any lower scale defect is the source of indication of the defect in the waterfall diagram. This work was out of the scope of this report and will be done in the next phase. The objective of this study (Phase 1A) was to demonstrate if the GWUT could be used for scanning welded joints which was achieved successfully. However, verification and validation of the GWUT will be done through known defects and damages (e.g. inserts) during Phase 1B midterm and final demonstration.

Test: Welded Lap Joint Between Two 8 Ply [0/90/0/90]s Plates
JSR settings [Voltage: 100V, Gain: 30 Db, Low Pass Filter: 3 MHz, High Pass Filter: 1 MHz, PRF: 1.25 kHz, Dampening: 333 Ohms, Pulser Impedance: HIGH, Energy Control: LOW]
Oscilloscope settings [Mode: 512 averaging, viewing window: 40 us, Y axis zoom: 5 mV]
Track Settings: [Angle Transducer/Receiver 54 degrees, Distance Apart: 2¾ inches, Increment: 3 mm]
Coupling: Ultrasonic Gel, Weld is free from water

Note: This scan was performed with ultrasound gel. Except diminishing ultrasound signal due to loss of the gel, no indication of defects was found. The lap joint is known to have no defects and is consistent with the GWUT scan results.

As shown above, the utility of GWUT method as a suitable post process NDE tool for thermoplastic welded joints is demonstrated. The Guided wave will split at the welded joint and will create multiple wave modes passing through the joint which could provide important features for defect detection through a waterfall diagram. The Waterfall diagram created using MATLAB code is the evidence of the arrival of multiple wave packets. A suitable band of angular orientation of ultrasonic transducers to generate guided wave mode with highest possible signal to noise ratio were found. The potential reason for using GWUT for its ability to scan large areas at a given time, allowing faster implementation of large scale NDE.

### *****First PowerPoint*****

Referring again to FIG. 4, guided waves 418 propagate in direction C along the distance between transducer 404 and receiver 410. Propagation of guided waves 418 depend on the material properties, such as number of layers and configurations of the layers, as well as incident angle and the input frequency of the probe. Guided waves 418 saturate the complete thickness of the material, herein composite plate 408, and wave frequency depends on the thickness. Transducer 404 and receiver 410 are coupled with the other testing structures utilizing media such as water, Ultrasound 412 Gel, and at times using non-contact method where the coupling media is air itself. Importantly, the guided wave instrumentation can be automated with robotics.

Find the appropriate angle 420 can be achieved analytically or computationally from dispersion curves. It can also be determined experimentally by tunning. Once the angle is determined, it is fixed for the testing setup. Further, a specific angle triggers a specific mode of the testing set-up as shown by the below equation:

$${θ}_{I} = {sin}^{- 1} ( \frac{{C}_{w}}{{C}_{pm}} )$$

$$wherein m = a , s$$

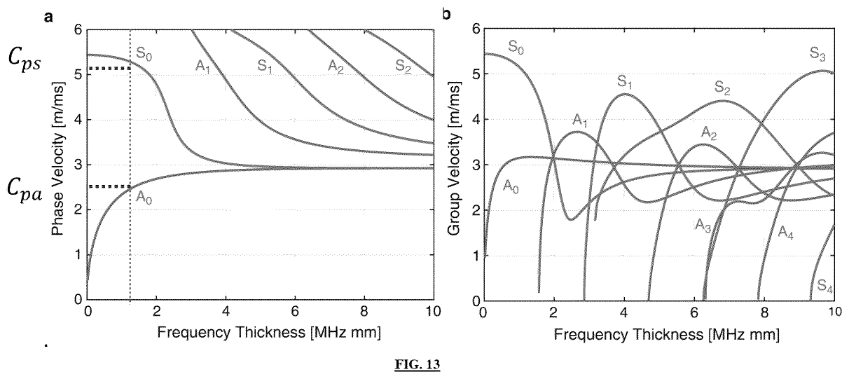

Changes in modes indicate defects in the material being tested, see FIG. 13 at a and b.

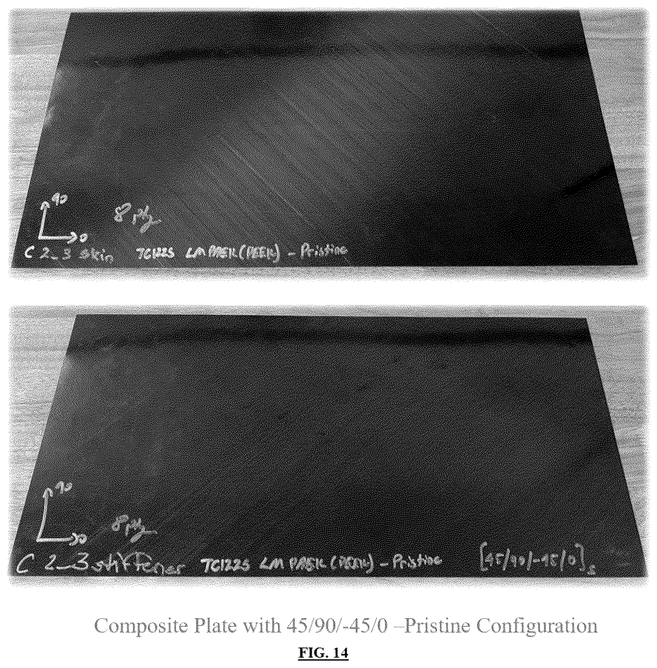

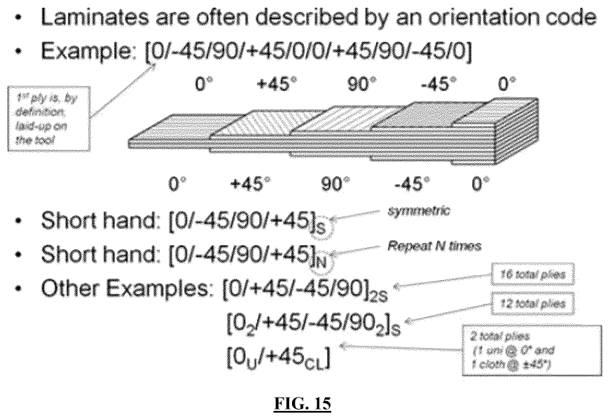

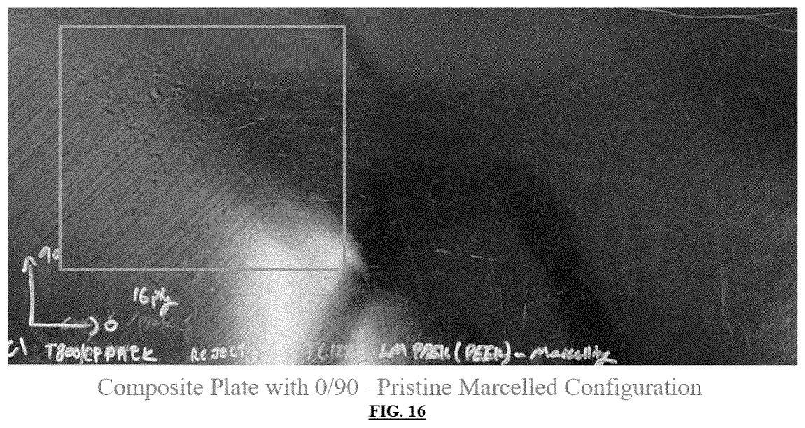

With respect to FIG. 14, the specimen consists of fiber layered at 45/90/−45/0 symmetric configurations. The fiber layers are stacked, and the layers are rotated about 45 degrees. Guided waves will be utilized to scan the plate signal will be captured followed by deduction of the wave packets. FIG. 15 illustrates how laminates are described by on orientation code. FIG. 16 shows a Composite Plate specimen with 0/90—Pristine Marcelled Configuration. The specimen consists of fiber layered at 45/90/−45/0 configurations. The fiber layers are stacked perpendicularly layer by layer. Marcelling is present due to improper layering. Guided waves will be utilized to scan the plate and the signals will be compared for the marcelling detection. Marcelling is in-plane waviness in the composites.

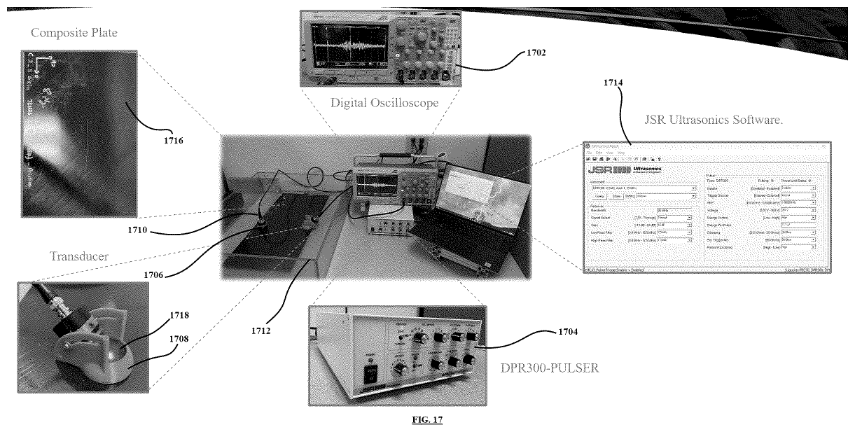

FIG. 17 shows a further testing setup of the current disclosure. This includes digital oscilloscope 1702, Pulser-Receiver 1704, acoustic transducer 1706, acoustic receiver 1708, acrylic transducer connector 1710, 3D Printed Rail and Holder for the Transducer and Receiver 1712, JSR Acoustic Software 1714, composite plate 1716, and acrylic hemisphere 1718.

Pulser-Receiver 1704 functions by generating burst signals sent to acoustic transducer 1706 and then receives the emitted signal with receiver 1712. It functions similar to an arbitrary function generator with additional versatile signal features. Pulser-Receiver 1704 includes different signal features like receiver gaining, high and low-pass filtering, pulse energy control, pulse amplitude and frequency control, transducer dampening, etc. Pulser-Receiver 1704 is equipped with two modes, mainly Pulse-Echo and Through modes. The Through mode utilizes an acoustic transducer (for emission) and a receiver (for receiving) the signal. A Pulse-Echo system utilizes a single device consisting of both transducer and receiver under a single platform.

Oscilloscope 1702 is a basic electronic device used frequently by different engineering fields for the capturing and monitoring the signals. Oscilloscope 1702 receives the signal in the form of voltage and plots it on a voltage amplitude vs. time scale. Multiple features can be utilized in the equipment such as scaling of the signals, averaging signals, sampling and triggering of signals, etc. In this experiment, an output terminal from pulser receiver 1704, which is basically the captured signal acoustic receiver 1708 will be directly fed to the input of oscilloscope 1702. Oscilloscope 1702 will be used to monitor the signals from pulser receiver 1704 and captured.

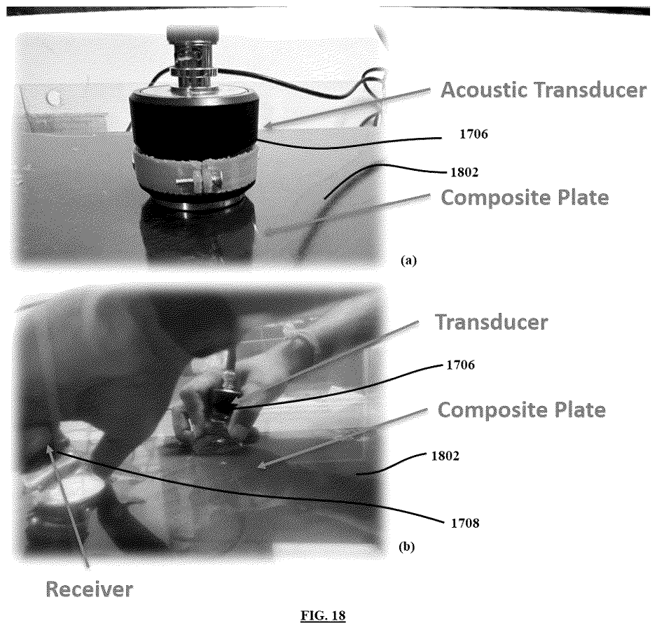

Acoustic transducer 1706 acts as an exciter where it emits the processed output signal (based on user's need) from pulser receiver 1704. Transducer 1706 will emit ultrasonic signals to user's specification which will propagate through composite plate 1802 in the form of guided waves. See FIG. 18. Acoustic receiver 1708 basically senses and receives the signal which is sent to pulser receiver 1704. The output terminal basically sends the acoustic receiver 1708 signal which is then monitored with oscilloscope 1702. Acoustic receiver 1704 in this case will capture the guided waves generated due to acoustic transducer 1706. In the Pulse-Echo Mode, acoustic transducer 1706 emits the signal and then it senses back like a receiver all under a single component, omitting the requirement of another receiver.

Acrylic based hemispherical connectors, acrylic hemisphere 1718, are incorporated with tip of acoustic transducer 1706 and tip of acoustic receiver 1708. Ultrasonic gel 412 is applied between acoustic transducer 1706 and composite plate 1802 and tops 1906 of both acoustic transducer 1706 and acoustic receiver 1708. This allows the waves to transmit into the composite plate 1802. Bottom 1904 of acrylic hemisphere 1718 is flat which allows the transitional movement along the surface of composite plate 1802. The tops 1906 allow for a ball joint like movement around a central pivot point in the semi-sphere. The hemispherical shape of acrylic hemisphere 1718 allows more freedom to rotate acoustic transducer 1706 on top 1906 of acrylic hemisphere 1718 to different angles and thus, optimizing the best angle of transmission and receival. Inverted hollow hemispherical connector 1902 lies between acoustic transducer 1706 and acrylic hemisphere 1718. Hollow 1908 of inverted hollow hemispherical connector 1902 matches the radius of acrylic hemisphere 1718 for ease of movement along the periphery.

3D printed casing 2002 case and track 2004 may be 3D printed using PLA. Track 2004 allows for a two-dimensional movement of acoustic transducer 1706 and acoustic receiver 1708 controlling the angle as it translates at a set length across the composite material. The best angle where the signal is strong and promising will be locked using casing 2002 and track 2004. Casing 2002 allows for movement around pivotal center 1910 of acrylic hemisphere 1718. Track 2004 is utilized for holding and sliding acoustic transducer 1706 and acoustic receiver 1708 that are positioned directly across from each other on composite plate 1802 (or whatever material is being tested) at a specific distance. The angles held by casing 2002 holding acoustic transducer 1706 and casing 2002 holding acoustic receiver 1708 will be identical.

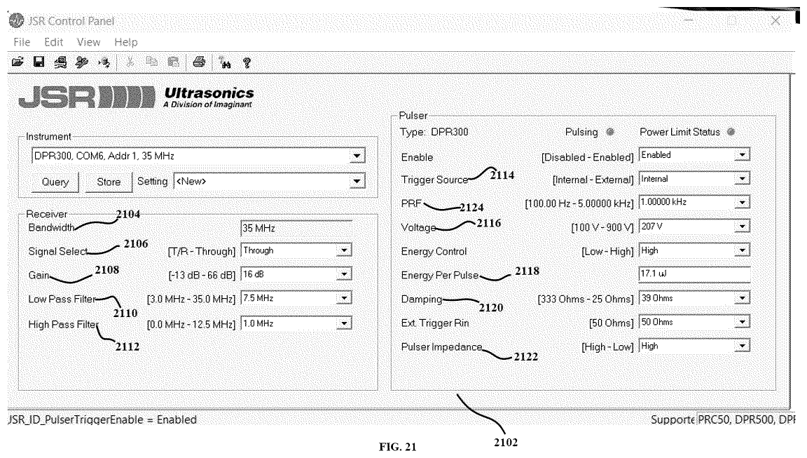

JSR Control panel 2102 of JSR acoustic software 1714 allows for digital control of pulser receiver 1704. See, FIG. 21. This allows for a more precise form of measurement when receiving the wave. The JSR Software consists of different parameters through which the signal excited can be refined and customized as per user's requirement. Following are the features that includes in the software: Bandwidth 2104, controls the overall range of the frequencies within an assigned band for signal transmission. Signal Select 2106, selects the type of signal for transmission. Mainly Pulse-Echo or Through type. Gain 2108, is the ratio of the output to input power. Basically, utilized for signal amplification. Low Pass Filter 2110, a filter that passes signals with a frequency lower than a selected cut-off frequency and attenuates signals with frequencies higher values. High Pass Filter 2112, a filter that passes signals with a frequency higher than a selected cut-off frequency and attenuates signals with frequencies lower values. Trigger Source 2114, selects whether the triggering of the signal is controlled internally or externally. Voltage 2116, is amount of voltage supplied to the signal emission. Energy per pulse 2118, is the amount of energy supplied per pulse of a signal transmission. It is usually in microjoules (uJ). Damping 2120 is a control of the Pulser which allows the damping impedance at the output to be set to a range. Pulser Impedance 2122, controls the impedance of the pulser. The control is to set it to either high or low.

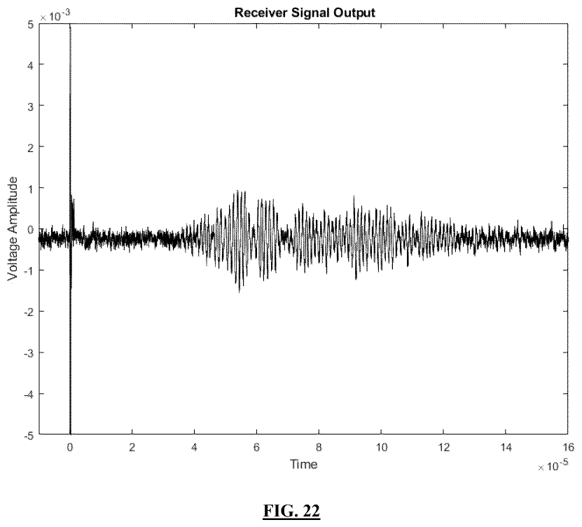

Acoustic transducer 1706 emits ultrasonic waves to composite plate 1802 when triggered. The waves propagates through composite plate 1802 in the form of guided waves. Due to reflections from different boundaries of composite plate 1802 and interferences, formation of the wavepackets can be observed. These wavepackets store vital information which can be quantified and extracted using different acoustic feature extraction methodology. See FIG. 22.

Acoustic transducer 1706 and acoustic receiver 1708 coupled with the hemispherical connector, acrylic hemisphere 1718, is attached aluminum alloy rails 2302 in 2D gantry shaped configuration 2304.

For initial troubleshooting, acoustic transducer 1706 and acoustic receiver 1708 will be brought closer to each other on composite plate 1802 and signals will be checked. The signals will be monitored from oscilloscope 1702 and will be calibrated. Acoustic transducer 1706 and acoustic receiver 1704 will be separated along x-axis (horizontal direction). The signals will start fading slowly and a distance must be fixed till the signal is distinctly visible. Different angles will be trialed and checked as angle of incidence for acoustic transmitter 1706 and acoustic receiver 1708 for a “sweet spot” where the output signal is highest. The angles of acoustic transducer 1706 acoustic receiver 1708 will be recorded, and they will be tightened in the “sweet spot” angle with the 3D holder. The signal will be calibrated and fine-tuned using the JSR acoustic software 1714, where multiple features such as Gain 2108, High Band Pass Filters 2112 and Low Band Pass Filter 2110, Voltage 2116, Energy Per Pulse 2118, PRF 2124, Damping 2120, etc. will be played and tuned to get high signal-to-noise ratio output.

Composite plate 1802 is almost 600 mm and acoustic transducer 1706 and acoustic receiver 1708 can be moved every 1-2 mm in y-direction (along the length) and record the time domain signal at each step. An estimated total of 600 signals will be captured and will be superimposed to derive a waterfall diagram. Four specimens will be scanned twice at every 600 points hence, 4×2×600 i.e., 4800 data points will be captured. Multiple acoustic feature extractions will be utilized for the damage/marcelling detection and quantification.

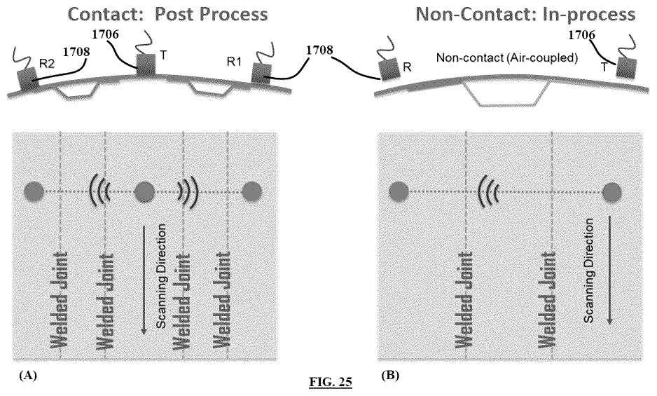

GWUT is highly applicable to High-Rate inspection of TPC welded joints at different stages: in-situ while welding, intermittent at different staged of welding, and post-welding for verification. GWUT provides a critical solution as a Key Enabler of the TPC manufacturing process. The current disclosure can provide high-speed inspection and characterization of Marcelling (in-plane waviness) in TPC. It also provides a critical solution as a Key Enabler to detect and quantify Marcelling Differentiation In-plane and Out-of-plane fiber waviness and GWUT can provide such an opportunity as a critical solution and a Key Enabler. Thus, GWUT is very fast and effect where Traditional UT is slower and less effective. Indeed, the current disclosure can provide inspection of bonded joints for stringers (adhesively or welded) delamination & disbonding (e.g., in-situ TPC welding, Hat, L and S stringer Joints). FIG. 25 shows that both contact, see FIG. 25 at (A), and non-contact configurations, see FIG. 25 at (B) are both feasible pursuant to the current disclosure.

GWUT is applicable for large area inspection where an open planar surface is available. Examples include fuselage skin with and without stringers, wing skin, wing leading and tailing edges, Engine inlet, Cowl, Fan Cowl etc. (flat thickness up to ~12.5 mm & ramp transition between 30 mm-5 mm). GWUT is applicable when only one side of a structure is accessible. GWUT is very well applicable for Ramps where ply count increases and/or decreases. GWUT is applicable for Honeycomb skins. It may also be used at sharp radii or joints where the radius of curvature at the bend is too small (~5 mm-20 mm).

Guided wave (GW) propagates over a long distance via acoustic transmitter 1706 and acoustic receiver 1708. The insonicated area by GW in a bounded structure is larger compared to typical Pulse-echo or Phased Array ultrasound. Defects are detected along a GW scanning path. GW saturates the complete thickness of the material and frequency depends on the thickness of the Structure. GW acoustic transmitter 1706 and acoustic receiver 1708 maybe coupled with a structure through Water, such as via using a water jet to couple to the tested surface, UGel, or other means. GW acoustic transmitter 1706 and acoustic receiver 1708 can also function as noncontact by being air coupled to a surface being tested. GW instrumentation may also be automated with robotics to gain high rate scanning. In use, GWUT is not meant to replace traditional UT but to guide much faster and tailored inspection location with urgent attention. GWUT is not applicable to detect discrete porosity (micro voids) of size below 500 micron but can detect cluster of voids in an area greater than 2 mm.

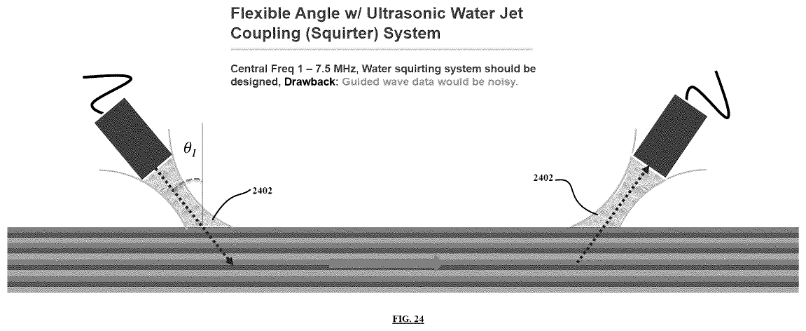

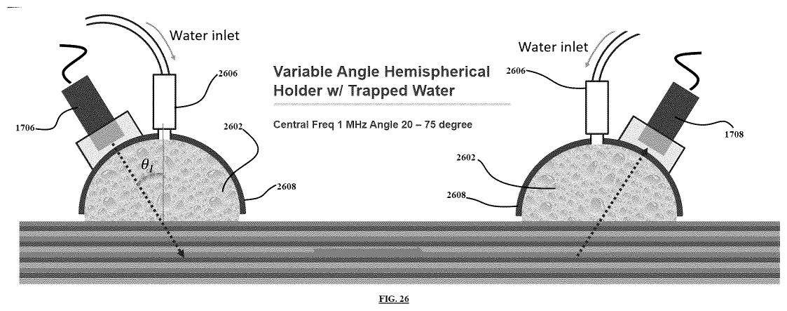

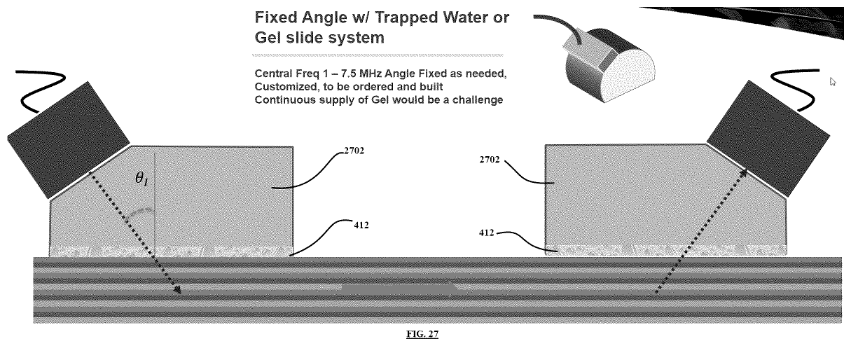

FIG. 26 shows an alternative configuration of the testing system where the acrylic members are replaced with water 2602 that contacts the surface being tested 2604 after being introduce via water inlets 2606 and held by water container 2608. In an even further embodiment, water container 2608 may be removed and a jet of directed water 2602 may be used to establish contact with the testing surface. Further, water container 2608 may be replaced with an angled block 2702, see FIG. 27, that fixes acoustic transducer 1706 and acoustic receiver 1708 at a preferred fixed angle with ultrasonic gel 412 serving to establish contact with the tested surface. This would allow for multiple, different angled blocks 2702 to be on standby and replaced depending on the type of material being tested without needing to recalibrate the tester and find the “sweet spot” angle as such would be known for the material and the appropriate angled block 2702 can be selected and placed into the system. These angles could vary from 0-90 degrees, such as from 20-75 degrees, including specific points with these ranges, such as 5, 7, 13, 24, 50, 85 degrees, etc. Angled blocks 2702 can be fashioned at any angle within these ranges. FIG. 24 shows a further embodiment where water jets 2402 may contact the testing surface.

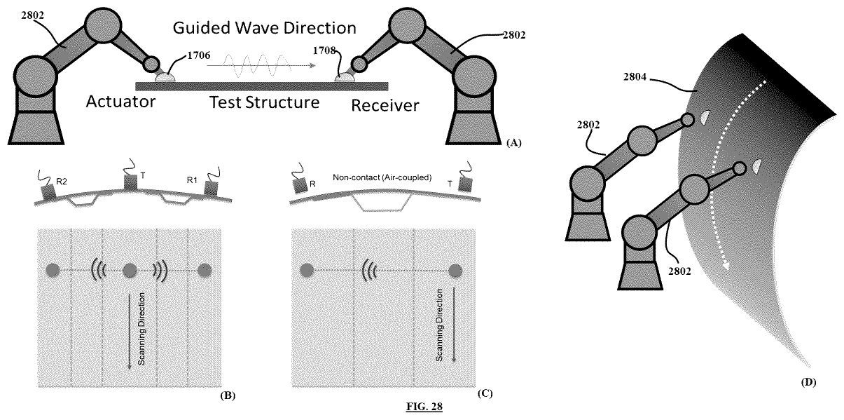

FIG. 28 shows a further embodiment wherein acoustic transducer 1706 and acoustic receiver 1708 are affixed to robotic arms 2802, see FIG. 28 at (A). As FIG. 28 at (B) and (C) illustrates, this could be a direct contact system or a non-contact system, such as air-based. As shown at (D), robotic arms 2802 allows for testing of curved surfaces 2804 in non-horizontal conditions over a host of angles varying from 0 to 180 degrees with respect to the horizon.

Further embodiments are illustrated in the following Examples which are given for illustrative purposes only and are not intended to limit the scope of the disclosure.

### Examples

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure. The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Various modifications and variations of the described methods, compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A nondestructive guided wave evaluation system comprising:
at least one transducer configured to direct wave energy into at least one material;
at least one receiver configured to receiver the wave energy emitted from the at least one material; and
wherein both the at least one transducer and the at least one receiver are configured to rotate on any plane about any axis in order to access at least one angle occurring on a surface of a hemisphere.

2. The nondestructive guided wave evaluation system of claim 1, further comprising wherein the guided wave is set to either a symmetric, antisymmetric or sheer horizontal mode.

3. The nondestructive guided wave evaluation system of claim 1, further comprising wherein the at least one transducer is mounted on a first robotic arm and the at least one receiver is mounted on a second robotic arm.

4. The nondestructive guided wave evaluation system of claim 1, further comprising wherein at least one pulser induces at least one ultrasound pulse in the at least one transducer.

5. The nondestructive guided wave evaluation system of claim 1, further comprising at least one oscilloscope configured to capture at least one signal emanating from the receiver.

6. The nondestructive guided wave evaluation system of claim 1, further comprising wherein the at least one transducer and the at least one receiver are positioned at two different locations along at least one weld.

7. The nondestructive guided wave evaluation system of claim 5, further comprising generating at least one waterfall diagram from the at least one signal emanating from the receiver.

8. The nondestructive guided wave evaluation system of claim 7, further comprising wherein a defect or anomaly in the at least one material creates a disruption or irregularity in the at least one waterfall diagram.

9. The nondestructive guided wave evaluation system of claim 1, further comprising determining a primary angle by locating a highest signal to noise ratio for the at least one material by moving the at least one transducer and at least one receiver along mirrored arcs with respect to one another and then positioning the at least transducer and the at least one receiver at the primary angle with respect to the at least one material.

10. The nondestructive guided wave evaluation system of claim 1, further comprising wherein the at least one transducer and the at least one receiver do not directly contact the at least one material.

11. A method of nondestructive guided wave evaluation of at least one material, the method comprising:
directing guided wave energy into at least one material using at least one transducer;
receiving, with at least one receiver, guided wave energy emitted from the at least one material; and
rotating at least one of the transducer and the receiver on any plane about any axis so as to access at least one angle occurring on a surface of a hemisphere.

12. The method of claim 11, further comprising setting the guided wave to one of a symmetric mode, an antisymmetric mode, or a shear-horizontal mode.

13. The method of claim 11, further comprising mounting the at least one transducer on a first robotic arm and mounting the at least one receiver on a second robotic arm.

14. The method of claim 11, further comprising inducing, by at least one pulser, at least one ultrasound pulse in the at least one transducer.

15. The method of claim 11, further comprising capturing, by at least one oscilloscope, at least one signal emanating from the at least one receiver.

16. The method of claim 11, further comprising positioning the at least one transducer and the at least one receiver at two different locations along at least one weld of the at least one material.

17. The method of claim 15, further comprising generating at least one waterfall diagram from the at least one signal captured from the at least one receiver.

18. The method of claim 17, further comprising detecting a defect or anomaly in the at least one material by identifying a disruption or irregularity in the at least one waterfall diagram.

19. The method of claim 11, further comprising determining a primary angle by locating a highest signal-to-noise ratio for the at least one material while moving the at least one transducer and the at least one receiver along mirrored arcs with respect to one another and then positioning the at least transducer and the at least one receiver at the primary angle with respect to the at least one material.

20. The method of claim 11, further comprising directing and receiving the guided wave energy from the at least one material without direct contact between the at least one transducer and the at least one receiver and the at least one material.
